(19) United States
(12) Patent Application Publication
(10) Pub. No.: US 2007/0044440 A1
(43) Pub. Date: Mar. 1, 2007

(54) Adjustable deflector inserts for air cleaners

(76) Inventor: James W. Davis, Los Angeles, CA (US)

Correspondence Address: Wald Diversified Corporation;James W. Davis, Chief Operating Officer, 12705 South Van Ness Avenue, Hawthorne, CA, 90250, US

(21) Appl. No.: 11/215,422

(22) Filed: Aug. 30, 2005

(51) Int. Cl. B01D 45/00

(52) U.S. Cl. 55/434

(57) ABSTRACT

Adjustable deflector inserts suitable for retrofit use with air cleaners are described. The adjustable deflector inserts are capable of being adjusted to fit a variety of different air cleaners and carburetors. One or more components of the adjustable deflector inserts may be manufactured in different configurations to fit different air cleaners and/or carburetors.

### FIELD OF THE INVENTION

The present invention relates to apparatuses for directing air flow from air filters into fuel/air mixing chambers of engines, and more particularly to air flow deflectors applicable to use within air filters located at the air intake of internal combustion engines.

### BACKGROUND OF THE INVENTION

Internal combustion engines, and in particular those which use carburetors, have for many years used air filters to remove unwanted particulates from the combustion air stream before it enters the engine. Standard, stock air filters have been supplied in a multitude of dimensions by auto manufacturers, with each filter being adapted to fit over the chosen carburetor. Stock air filters have normally been provided without any particular emphasis on a design configuration that would tend to minimize pressure drop of the air stream as it flows through the device, or that would tend to provide a uniform flow downward air flow into the carburetor. Such air filters have generally been of the type in which air is drawn radially inwardly through a vertical wall of a normally cylindrical air filter. In such devices, the air stream churns turbulently about in proximity of the center of the filter before being drawn downwards into the carburetor beneath the filter.

### BRIEF DESCRIPTION OF THE DRAWINGS

FIG. 1A shows one embodiment of an adjustable deflector insert in accordance with the present invention, as installed in an air cleaner.

FIGS. 1B and 1C show one embodiment of a deflector insert in accordance with the present invention.

FIG. 1D shows another embodiment of a deflector insert in accordance with the present invention.

FIGS. 2A-2D show alternative embodiments of a deflector insert in accordance with the present invention.

### DETAILED DESCRIPTION OF PREFERRED EMBODIMENTS OF THE INVENTION

The present invention is directed towards a deflector insert for enhancing efficiency of flow in air filters. Adjustable deflector inserts in accordance with the present invention are adaptable to retrofit use, and are simple, lightweight, relatively inexpensive, and easy to manufacture. In addition, they provide a significant, additional measure of power in high performance engines.

Adjustable deflector inserts in accordance with the present invention improve the efficiency of air/fuel mixing by improving and smoothing the flow path and reducing the pressure drop through air filters on internal combustion engines. Adjustable deflector inserts in accordance with the present invention:
can be manufactured in a simple, straightforward manner of non-corrosive materials;
can be adapted by installation personnel to quickly establish an interfitting pattern within existing air filters which avoids any leakage of air around the filter element; and
in a relatively inexpensive manner can improve performance, efficiency and horsepower in automotive engines.

Adjustable deflector inserts in accordance with the present invention provide higher efficiency and lower pressure drop across the air filter than do conventional air filters. This performance factor and lower pressure drop is significant in various types of high performance automotive machinery design. The lower pressure drop requirements and more uniform fluid flow made possible by use of these adjustable deflector inserts allows higher combustion efficiencies by allowing more uniform fuel-air mixtures to be provided by the carburetor system. Moreover, this combination makes feasible more powerful performance of an existing engine. In particular, adjustable deflector inserts in accordance with the present invention provide better engine response and better airflow, which results in increased horsepower.

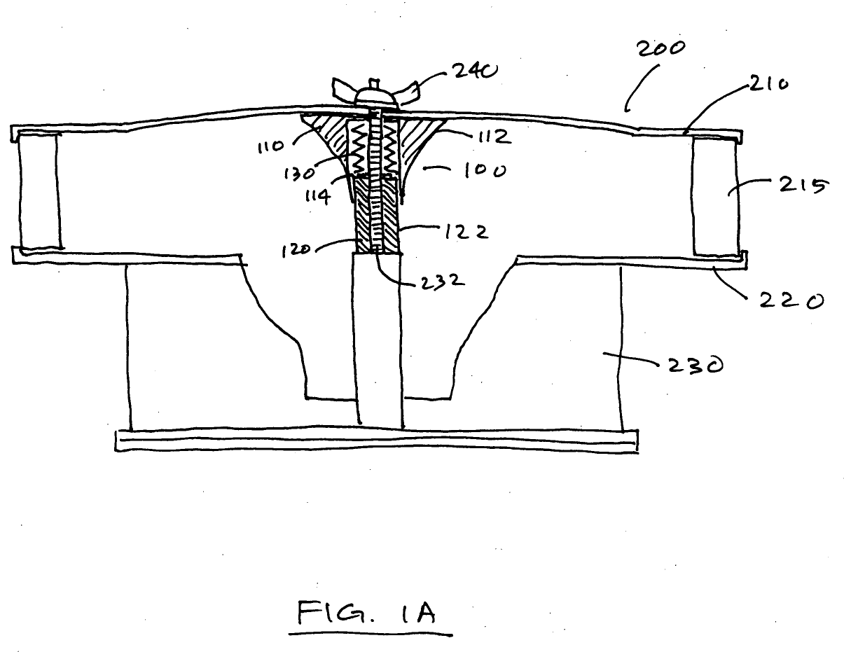

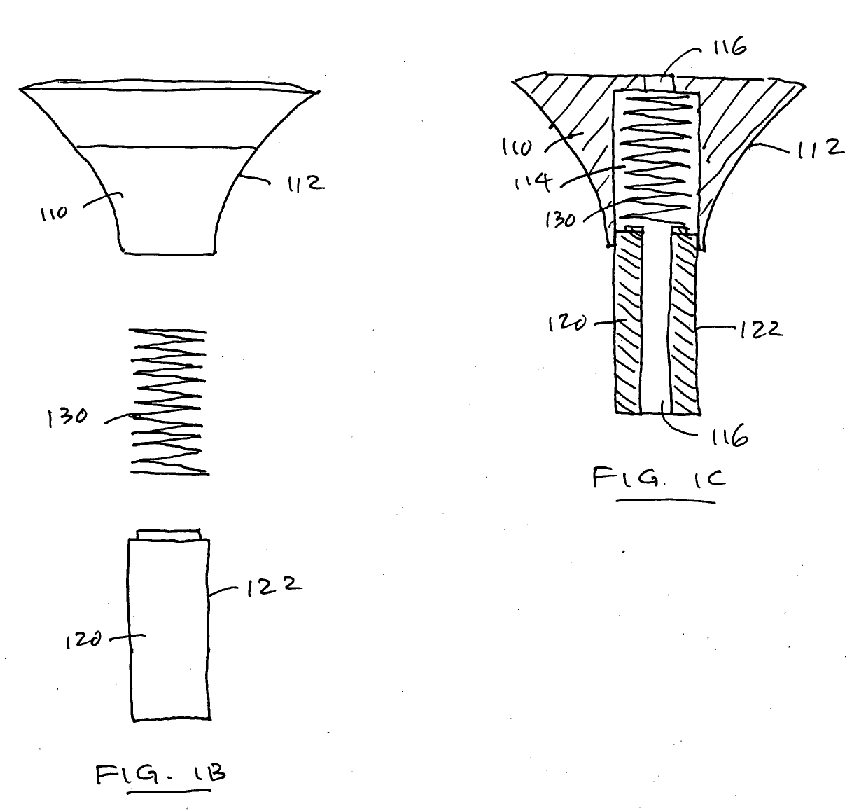

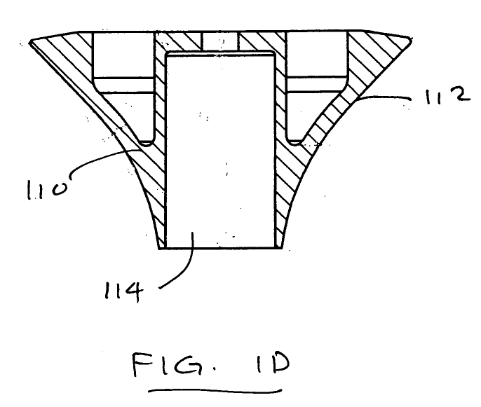

FIG. 1A shows one embodiment of an adjustable deflector insert 100 in accordance with the present invention, as installed in an air cleaner 200. Air cleaner 200 includes a lid 210, an air filter element 215, and a base 220. Base 220 is coupled to the top of a carburetor 230. Carburetor 230 includes a stud 232 which extends through a hole in lid 210. A fastener 240 attaches to stud 232 and holds lid 210 in place, which in turn holds air filter element 215 in place.

Deflector insert 100 is installed between the bottom of lid 210 and carburetor 230. Deflector insert 100 is adjustable to fit the distance between the bottom of lid 210 and the carburetor 230, thus allowing deflector insert 100 to be used with a variety of different air cleaners and carburetors.

FIGS. 1B and 1C show one embodiment of a deflector insert 100 in accordance with the present invention. Deflector insert 100 includes an upper section 110 and a lower section 120. Upper section 110 has an upper section side surface 112. Upper section side surface 112 has a perimeter that decreases from the top to the bottom of upper section 110. Lower section 120 is adjustably coupled to upper section 110. Lower section 120 has a lower section side surface 122. The side surfaces of deflector insert 100 may be smooth, coarse, fluted, ribbed, stepped, or any suitable texture. FIG. 1D shows an alternative embodiment of upper section 110 which uses less material.

In the embodiments shown, upper section 110 and lower section 120 are telescopically coupled, with lower section 120 capable of sliding into a cavity 114 in upper section 110. A spring 130 is located in cavity 114 and biased against both upper section 110 and lower section 120. Spring 130 allows deflector insert 100 to expand so that upper section 110 fits against the bottom of lid 210, and lower section 120 fits against carburetor 230. Upper section 110 and lower section 120 include openings 116 and 126 which allow stud 232 to pass through.

Deflector insert 100 may be substantially solid, or it may be hollow or partially hollow with struts or other appropriate structure for allowing stud 232 to pass through. Deflector insert 100 may be made of a substantially rigid material, or one or more sections of a non-rigid material which would allow it to deform to fit different air cleaners and carburetors. Deflector insert 100 may also include an integrated stud 232, which would allow it to be threaded onto carburetor 230.

In operation, air is drawn through air filter element 215 and into air cleaner 200. The air is then turned by the upper section side surface 112 and the lower section side surface 122 of deflector insert 100 into carburetor 230. Deflector insert 100 seeks to turn air drawn into air cleaner 200 and smoothly redirect the air into carburetor 230.

Upper section side surface 112 and lower section side surface 122 of deflector insert 100 may have any suitable cross-sectional profile. In the embodiment shown, deflector insert 100 has an upper section side surface 112 with a circular cross section that decreases in radius at a variable rate from the top to the bottom of upper section 110, and a lower section side surface 122 with a uniformly circular cross section. However, upper section side surface 112 and lower section side surface 122 may have any suitable cross section, such as square or elliptical, and the perimeter of this cross section may vary at any rate, such as a constant rate. Upper section side surface 112 and lower section side surface 122 may also have portions with different cross sections, as described below.

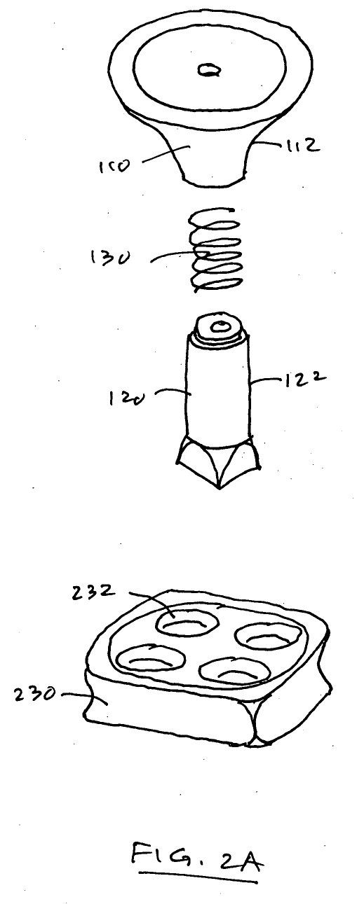

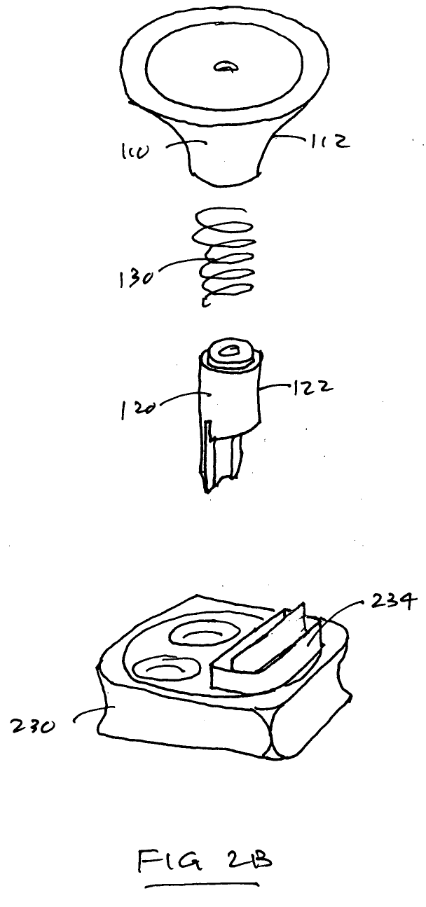

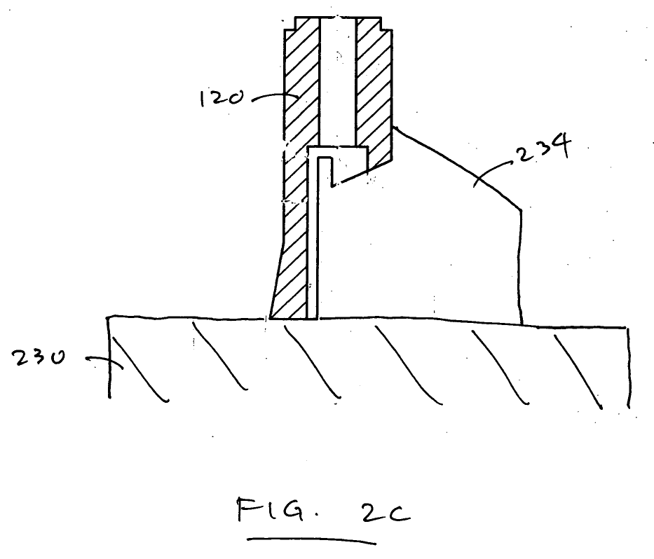

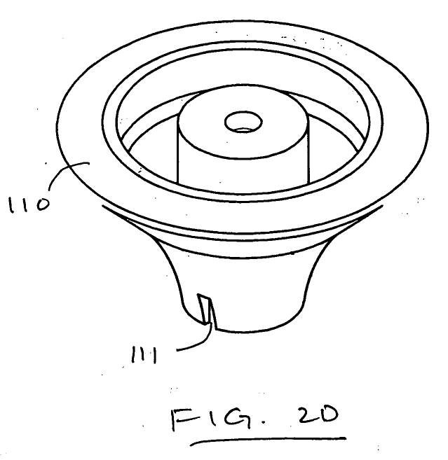

FIGS. 2A-2C show alternative embodiments of deflector insert 100 having other cross-sectional profiles, along with carburetors they may be used with. FIG. 2A shows a deflector insert 100 with a lower section 120 having a portion with a cross section that is circular, and another portion with a cross section that is squarish with concave sides. This cross-sectional profile is suitable for use with a carburetor 230 that includes four ports 232. Lower section 120 may include a small tab or wire which allows it to remain properly aligned with ports 232. Alternatively, double-sided tape or an adhesive may be used to keep lower section 120 properly aligned with ports 232. FIG. 2B shows a deflector insert 100 having a lower section 120 suitable for use with a carburetor 230 that has two of four ports surrounded by a choke tower 234. As shown in FIG. 2C, lower section 120 is properly shaped to allow it to fit choke tower 234. FIG. 2D shows an alternative embodiment of upper section 110 that has a slot 111 that configured to fit choke tower 234.

Deflector insert 100 may be adjustable in any suitable way. For example, deflector insert 100 may come as a kit with one or more sections or spacers of different sizes which may be interchanged and assembled to adjust deflector insert 100 to a desired height. The sections may include lips, tabs, ribs and/or other features to facilitate assembly and/or proper alignment of the individual sections. As another example, upper section 110 and lower section 120 may be threaded, allowing adjustment by turning upper section 110 relative to lower section 120.

Adjustable deflector inserts in accordance with the present invention may be easily adapted to other embodiments incorporating the concepts taught herein. Thus, the adjustable deflector inserts may be embodied in other specific forms without departing from the spirit or essential characteristics thereof. Therefore, the embodiments presented herein are to be considered in all respects as illustrative and not restrictive, the scope of the invention being indicated by the appended claims rather than by the foregoing description, and all changes which come within the meaning and range of equivalences of the claims are therefore intended to be embraced therein.

What is claimed is:

1. An adjustable deflector insert for use with an air cleaner coupled to a carburetor, the air cleaner having a lid and a base, the adjustable deflector insert comprising:
an upper section having an upper section side surface, the upper section side surface having a perimeter that decreases from a top of the upper section to a bottom of the upper section;
a lower section adjustably coupled to the upper section, the lower section having a lower section side surface;
wherein the upper section and the lower section can be adjusted so that the upper section fits against a bottom of the air cleaner lid and the lower section fits against the carburetor; and
wherein air drawn into the air cleaner is directed by the upper section side surface and the lower section side surface into the carburetor.

2. The adjustable deflector insert of claim 1, wherein the upper section has a cross-section that is substantially circular.

3. The adjustable deflector insert of claim 1, wherein at least a portion of the lower section has a cross-section that is substantially circular.

4. The adjustable deflector insert of claim 1, wherein at least a portion of the lower section has a cross-section that is squarish with concave sides.

5. The adjustable deflector insert of claim 1, wherein the lower section is slidingly coupled to the upper section.

6. The adjustable deflector insert of claim 1, wherein the upper section defines a cavity and the upper section receives at least a portion of the lower section in the cavity.

7. The adjustable deflector insert of claim 6, further comprising a spring located in the cavity, the spring capable of biasing the upper section against the bottom of the air cleaner lid and the lower section against the carburetor.

8. An adjustable deflector insert for use with an air cleaner coupled to a carburetor, the air cleaner having a lid and a base, the adjustable deflector insert comprising:
means for redirecting air drawn into the air cleaner into the carburetor; and
means for adjusting the means for redirecting so that the means for redirecting fits against a bottom of the air cleaner lid and against the carburetor.

9. The adjustable deflector insert of claim 8, wherein the means for redirecting air includes:
an upper section having an upper section side surface, the upper section side surface having a perimeter that decreases from a top of the upper section to a bottom of the upper section; and
a lower section adjustably coupled to the upper section, the lower section having a lower section side surface.

10. The adjustable deflector insert of claim 9, wherein the upper section has a cross-section that is substantially circular.

11. The adjustable deflector insert of claim 9, wherein at least a portion of the lower section has a cross-section that is substantially circular.

12. The adjustable deflector insert of claim 9, wherein at least a portion of the lower section has a cross-section that is squarish with concave sides.

13. The adjustable deflector insert of claim 8, wherein the means for adjusting includes a cavity in the upper section capable of receiving at least a portion of the lower section.

14. The adjustable deflector insert of claim 13, wherein the means for adjusting includes a spring located in the cavity, the spring capable of biasing the upper section against the bottom of the air cleaner lid and the lower section against the carburetor.

15. A method for redirecting air drawn into an air cleaner into a carburetor, the air cleaner having a lid and a base, the method comprising:
providing an adjustable deflector insert, the adjustable deflector insert having:
an upper section having an upper section side surface, the upper section side surface having a perimeter that decreases from a top of the upper section to a bottom of the upper section;
a lower section adjustably coupled to the upper section, the lower section having a lower section side surface;
wherein the upper section and the lower section can be adjusted so that the upper section fits against a bottom of the air cleaner lid and the lower section fits against the carburetor; and
wherein air drawn into the air cleaner is directed by the upper section side surface and the lower section side surface into the carburetor;
installing the adjustable deflector insert in the air cleaner between the air cleaner lid and the carburetor.

16. The method of claim 15, wherein the upper section has a cross-section that is substantially circular.

17. The method of claim 15, wherein at least a portion of the lower section has a cross-section that is substantially circular.

18. The method of claim 15, wherein at least a portion of the lower section has a cross-section that is squarish with concave sides.

19. The method of claim 15, wherein the lower section is slidingly coupled to the upper section.

20. The method of claim 15, wherein the upper section defines a cavity and the upper section receives at least a portion of the lower section in the cavity.

21. The method of claim 15, further comprising a spring located in the cavity, the spring capable of biasing the upper section against the bottom of the air cleaner lid and the lower section against the carburetor.
